(19) United States
(12) Patent Application Publication
(10) Pub. No.: US 2015/0272807 A1
(43) Pub. Date: Oct. 1, 2015

(54) EXOSKELETON FOR ESSENTIAL TREMOR AND PARKINSON'S DISEASE

(71) Applicant: BOARD OF TRUSTEES OF NORTHERN ILLINOIS UNIVERSITY, Dekalb, IL (US)

(72) Inventors: Abhijit Gupta, Naperville, IL (US); Ryan Riddel, Dekalb, IL (US); Randeep Sra, Naperville, IL (US)

(21) Appl. No.: 14/670,117

(22) Filed: Mar. 26, 2015

Related U.S. Application Data
(60) Provisional application No. 61/971,141, filed on Mar. 27, 2014.

(51) Int. Cl. A61H 1/02; A61H 99/00

(52) U.S. Cl. CPC A61H 1/0274; A61H 99/00; A61H 2201/5007; A61H 2205/06; A61H 2230/605

(57) ABSTRACT

An exoskeleton device having embedded software for moderating involuntary movements, for example, of a patient afflicted with Parkinson's Disease or Essential Tremor, the exoskeleton comprising at least one cuff fitted to the patient, a motor configured to drive the cuff to apply torque to an arm of the patient enclosed in the cuff, gyroscopes and accelerometers configured to detect movement of the arm and to generate signals indicative of the movement, digital filters for distinguishing portions of the signal reflecting voluntary movement from portions of the signal reflecting involuntary movement, and a control system configured to operate the motors such that the torque applied to the arm of the patient counters the involuntary movement but permits voluntary movement.

### CROSS REFERENCE TO RELATED APPLICATIONS

This application claims the benefit of priority under 35 U.S.C. §119(e) to U.S. Provisional Application No. 61/971,141, filed Mar. 27, 2014, which is incorporated herein by reference in its entirety.

### BACKGROUND

According to the U.S. National Library of Medicine, Parkinson's Disease (“PD”) is a disorder of the brain that leads to involuntary or uncontrolled movements (e.g., vibrations, shaking, or tremors) and difficulty with walking, movement, and coordination. Essential Tremor (“ET”) involves uncontrolled vibration, shaking, or tremors of the hand or fingers. Many people suffer from Parkinson's Disease, Essential Tremor, or other afflictions that cause involuntary or uncontrolled movements of hands or limbs.

These diseases prohibit affected people from performing specific tasks requiring dexterity. While the diseases may not lead to death for the patients, patients suffer from not being able to perform simple day-to-day tasks, which can be disturbing and humiliating for the affected patients. The diseases may also prohibit affected patients from meaningful employment.

Existing treatment options include medicines and surgical treatments, but these options may present serious side effects, may not work for all affected people, and may not provide therapeutic benefit for a long period of time. Moreover, existing pharmacological and surgical treatments provide relief from some motor symptoms, but do not halt the ultimate progression of the disease.

Some researchers have attempted treatments involving electromechanical devices as an alternative to medicine or surgery, but these efforts have not resulted in devices acceptable to the medical community. Certain attempts added mechanical loads to control various types of tremors, or added force and inertia on pathological tremors in order to alter the properties of a pathological tremor. By way of example, previous attempts have employed techniques such as viscous damping or adding inertia to suppress tremors. Such approaches have suffered from attenuation of the total motion of the patient's hands and involved equipment having considerable weight, thus requiring considerable muscle strength on the part of the patients. Some prior attempts failed to take into account the decoupling of a gravity signal. Still other attempts have not been useful for low to moderate tremor, or suffered from other implementation problems, such as negative gain. Finally, prior attempts used software that was not suitable for use on embedded systems.

### SUMMARY

According to the present disclosure, systems, components and methods are provided for helping patients afflicted with Essential Tremor (ET) or Parkinson's Disease (PD) by moderating the patients' involuntary movements (such as vibration, shaking, or tremors) of the hand, wrist, and/or arm using active vibration control principles. According to illustrative embodiments, signals representing involuntary movements are monitored, measured, and analyzed to compute the torque necessary to stabilize the hand, wrist, or arm. The computed torque is applied through an exoskeleton which contains motors and is attached to a patient's upper and lower arms, thus allowing the patient to maneuver substantially free of involuntary movements.

According to one aspect of the present disclosure, the device is a noninvasive exoskeleton which can be used by anyone suffering from uncontrolled vibration of the hand, wrist, and/or arm. This approach prevents the need for medicine or surgical procedures, minimizing side effects from medicine and surgery and requiring less medical supervision. Whereas surgery is often not reversible, a patient can stop using the device disclosed herein at any time. The device is designed using an active vibration control principle for patients irrespective of frequency and amplitude of vibration, and as a result the device will work without the need to test and classify whether the patient's affliction is PD, ET, MS, or something else.

According to another aspect of the present disclosure, the exoskeleton device is inexpensive, uses motors that do not require large current or voltage or large batteries, does not require any specialized hardware, and is built using inexpensive, commercially available, “off the shelf” items. Moreover, the device does not require hardware or software components that require third-party permissions, such as from commercial hardware or software providers like National Instruments or MATLAB.

According to another aspect of the present disclosure, the algorithms used to drive the exoskeleton's motors are implemented in software that is conducive for compilation to and execution on microcontrollers. This makes the software suitable for use in an embedded system, which provides particular advantages for patients who need the device to have portability.

According to another aspect of the present disclosure, the systems, methodologies, and components described herein are customizable for specific patients. The characteristics of filtering components and of control systems are algorithmically determined based on clinical data for a particular patient, such that the filtering components and control systems are programmed with parameters that are optimized for a particular patient. Moreover, the systems, methodologies, and components are suitable for use irrespective of the frequency and amplitude of the vibrations for a particular patient that are to be controlled. Finally, the device can be custom fitted to any patient at a low cost using 3D printing technology.

Additional features of the present disclosure will become apparent to those skilled in the art upon consideration of the illustrative embodiments described herein.

### BRIEF DESCRIPTION OF THE DRAWINGS

The detailed description refers to the accompanying figures, in which:

FIG. 1 shows a system block diagram in accordance with the present disclosure.

FIG. 2 shows a block diagram depicting the relationship between system hardware components in accordance with the present disclosure.

FIG. 3 shows a side perspective view of structural features of a forearm portion of an exoskeleton in accordance with the present disclosure.

FIG. 4 shows a back perspective view of structural features of a forearm portion of an exoskeleton in accordance with the present disclosure.

FIG. 5 shows an exploded perspective view of structural features of a forearm portion of an exoskeleton in accordance with the present disclosure.

FIG. 6 shows a top perspective view of structural features of a forearm portion of an exoskeleton in accordance with the present disclosure.

FIG. 7 shows a connection between components of an exoskeleton with a workstation used for diagnostic analysis.

FIG. 8 shows a side perspective photograph of a partial exoskeleton in accordance with the present disclosures.

FIG. 9 shows a side angled perspective view of structural features of a forearm portion of an exoskeleton in accordance with the present disclosure.

FIG. 10 shows a side angled, exploded perspective view of structural features of a forearm portion of an exoskeleton in accordance with the present disclosure.

FIG. 11 shows a close-up and transparent perspective view of structural features of an exoskeleton that allow for supination and pronation in accordance with the present disclosure.

FIG. 12 shows a side angled perspective view of structural features of an exoskeleton showing both forearm and bicep portions in accordance with the present disclosure.

FIG. 13 shows a transparent, side angled perspective view of structural features of an exoskeleton showing both forearm and bicep portions in accordance with the present disclosure.

FIG. 14 shows a transparent, side angled, exploded perspective view of structural features of an exoskeleton showing both forearm and bicep portions in accordance with the present disclosure.

FIG. 15 shows a side perspective view of structural features of an exoskeleton showing both forearm and bicep portions in accordance with the present disclosure.

FIG. 16 shows a transparent, side perspective view of structural features of an exoskeleton showing both forearm and bicep portions in accordance with the present disclosure.

FIG. 17 shows a front perspective view of structural features of an exoskeleton showing both forearm and bicep portions in accordance with the present disclosure.

FIG. 18 shows a transparent, front perspective view of structural features of an exoskeleton showing both forearm and bicep portions in accordance with the present disclosure.

FIG. 19 shows a top perspective view of structural features of an exoskeleton showing both forearm and bicep portions in accordance with the present disclosure.

FIG. 20 shows a transparent, top perspective view of structural features of an exoskeleton showing both forearm and bicep portions in accordance with the present disclosure.

FIG. 21 shows an exploded perspective view of a gearbox in accordance with the present disclosure.

FIG. 22 shows a transparent perspective view of a gearbox in accordance with the present disclosure.

FIG. 23 shows an alternative perspective view of a gearbox in which an axle of a motor assembly is shown in accordance with the present disclosure.

### DETAILED DESCRIPTION

The systems, methods, and components of the present disclosure are implemented on hardware and software components provided within an exoskeleton that is wearable by a patient suffering from Parkinson's Disease, Essential Tremor, or other afflictions that lead to involuntary or uncontrolled movements (e.g., vibrations, shaking, or tremors). In the disclosed embodiments, the patient wears the exoskeleton on his or her arm, wrist, and/or hand, but similar principals could be used for exoskeletons worn on other parts of a patient's body.

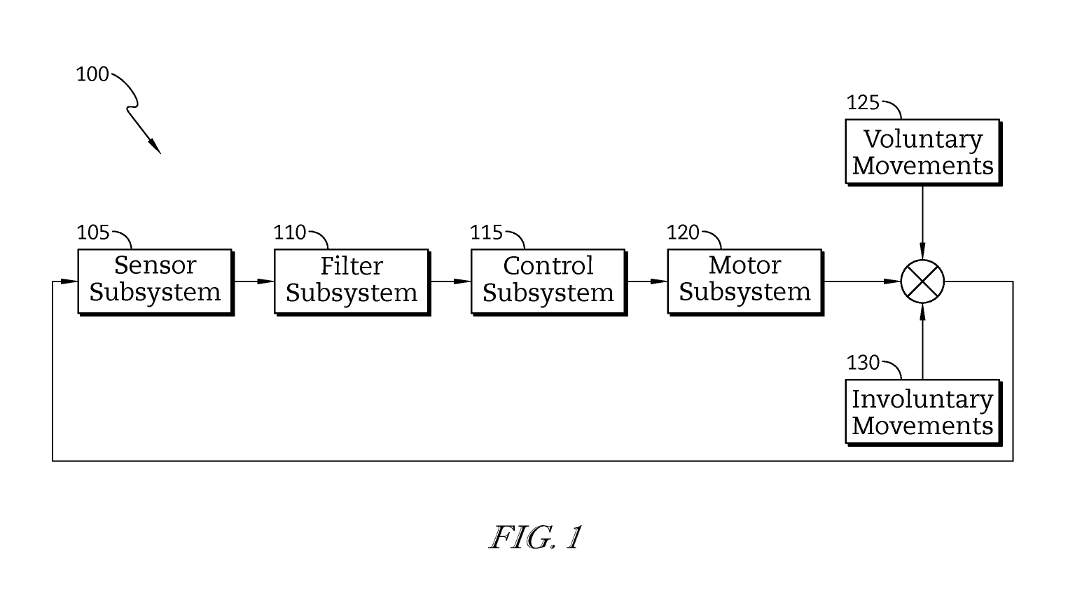

In illustrative embodiments, FIG. 1 shows a block diagram of a system 100 in accordance with the present disclosure. The system 100 includes a sensor subsystem 105, a filter subsystem 110, a control subsystem 115, and a motor subsystem 120. These subsystems are implemented in hardware and software components provided on a partial exoskeleton 300 or an exoskeleton 900, whose structural features will be described in more detail below. FIG. 1 also depicts the patient's voluntary movements 125 and involuntary movements 130.

The sensor subsystem 105 includes sensors that are placed in particular locations on the partial exoskeleton 300. The sensors are any devices that detect movement of a structure on which the sensors are disposed. In certain embodiments, the sensors include accelerometers and/or gyroscopes. The use of both accelerometers and gyroscopes allows the system 100 to take into account both acceleration information and spatial orientation information of the patient's arm, wrist, and/or hand. In certain embodiments, the accelerometers and gyroscopes are provided using microelectromechanical systems (MEMS) fabrication techniques, which are conducive for implementing the accelerometers and gyroscopes as part of an embedded system. In certain implementations, the sensor subsystem 105 includes digital, high-resolution gyroscopes and accelerometers.

The number of accelerometers and/or gyroscopes used on the partial exoskeleton 300 and their specific placement may vary. Additional accelerometers and/or gyroscopes placed at additional locations will result in additional information on the magnitude and direction of the patient's involuntary movements. Thus, to control involuntary pronation or supination of the forearm (i.e., rotation about the axis defined by the forearm), one can include an accelerometer and a gyroscope on a forearm portion of the partial exoskeleton 300. To control involuntary flexion or extension around the elbow, one can also include an accelerometer and a gyroscope on a forearm portion of the partial exoskeleton 300. To control involuntary flexion or extension around the wrist, one can include an accelerometer and a gyroscope on a wrist portion of an exoskeleton.

The sensor subsystem 105 measure movements of the patient's arm and generate output signals that are transmitted to the filter subsystem 110. The filter subsystem 110 includes one or more filtering components. According to the disclosed embodiments, the system 100 is implementing in the digital domain, so the filter subsystem 110 includes digital filtering components. If the sensor subsystem 105 provides signals in the analog domain, the system 100 may include an analog-to-digital converter that converts the signals to the digital domain prior to the signal being transmitted to the filter subsystem 110.

The filter subsystem 110 may include a Fast Fourier Transform (FFT) component, which characterizes the signals representing the patient's arm movements in the frequency domain. A Fast Fourier Transform is a common signal processing technique for converting time domain representations of a signal into frequency domain representations of a signal, as is known in the art. The filter subsystem 110 may also include one or more high pass filters. A high pass filter is used because the partial exoskeleton 300 should allow the patient's voluntary movements to proceed unimpeded, but should control and minimize the patient's involuntary movements. Generally, involuntary movements involve high frequencies. Thus, the filter subsystem 110 isolates the high frequency portions of a signal and allows them to pass, such that the control subsystem 115 can process the high frequency portions representing involuntary movements in order to control and minimize them. The low frequency portions of the signal are generally suppressed and not controlled because the partial exoskeleton 300 should not interfere with the patient's voluntary movements, which are generally low frequency motions.

Thus, if the input to the filter subsystem 100 is generally linear to within certain bounds, no response from motors in motor subsystem 120 will be generated. On the other hand, if the amplitude and/or frequency of a motion is above a certain threshold, the motor will operate to compensate against that motion.

In certain embodiments, the filter subsystem 110 includes filters that implement weighted moving average techniques for filtering high frequency motion from low frequency motion. In certain embodiments, the filter subsystem 110 includes infinite impulse response functions for performing filtering operations.

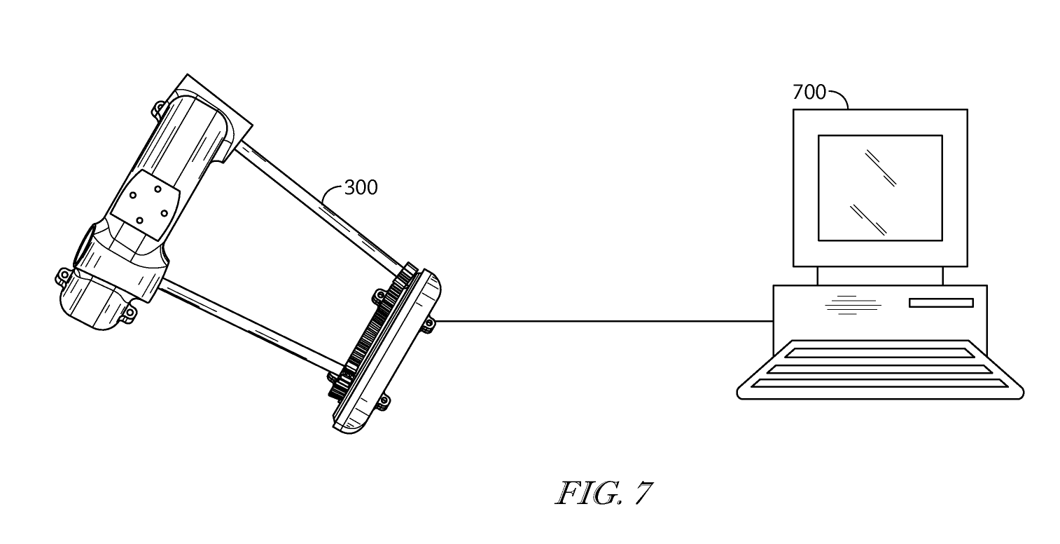

In certain embodiments, the filtering components of filter subsystem 110 are customized for a specific patient. By way of example, the characteristics of a digital filter can be described through a transfer function's parameters. The coefficients used for the filtering components in filter subsystem 110 can be customized for a specific patient. To achieve the customization, data is collected about a patient (as will be described in more detail in connection with FIG. 7), including data that characterizes the patient's voluntary movements and involuntary movements. A system implementer can then adjust the transfer function of filtering components as to more precisely isolate involuntary movements from voluntary movements for that patient. The transfer functions can be further refined through iterative trial and error, in which a patient using the partial exoskeleton 300 provides oral feedback about the performance of the partial exoskeleton 300. Alternatively, the transfer functions could be iteratively adjusted through automated techniques, such as through machine learning algorithms.

The signals from the filter subsystem 110 are then transmitted to the control subsystem 115, which operates to generate signals that can control moderate, and counter the patient's involuntary movements. A Proportional Integral Derivative Controller (“PID”) may be used for the control subsystem 115. In certain embodiments, a specialized algorithm generates the coefficients for the PID that are specifically selected as suitable for the patient wearing the partial exoskeleton 300. In illustrative embodiments, the algorithm used could be similar to the Ziegler-Nichols method for finding PID constants. Thus, the control subsystem 115 generates signals that will operate to control and moderate the patient's involuntary movements.

The signals from the control subsystem 115 are transmitted to the motor subsytem 120 (which may include one or more motors). The motor subsystem 120 drives engagement features (to be described in more detail below) that operably engage portions of the partial exoskeleton 300. Because the partial exoskeleton 300 is fitted to the patient, the movement of the motors in motor subsystem 120 results in force being applied to the patient's arm. In certain embodiments, two motors are placed on the partial exoskeleton 300 near a patient's elbow to drive engagement features that control involuntary flexion or extension related to bicep and/or tricep movements. In certain embodiments, three motors are placed by the patient's forearm to drive engagement features that control involuntary pronation or supination of the patient's forearm/hand/wrist.

The motors can be DC brushless motors or stepper motors. To compensate for the patient's involuntary movements, a DC brushless motor may be provided with an appropriate variable current. Alternatively, a stepper motor may be provided with an appropriate number of steps.

In operation, the motors in motor subsystem 120 drive structures that apply torque forces to the patient's arm. Those forces are applied to (and operate to offset) the patient's involuntary movements 130. The effect of the motors in motor subsystem 120, the involuntary movements 130, and the voluntary movements 125 combine to result in the net overall movement of the patient's arm. These movements are detected by the sensor subsystem 105, at which point the above-described process repeats.

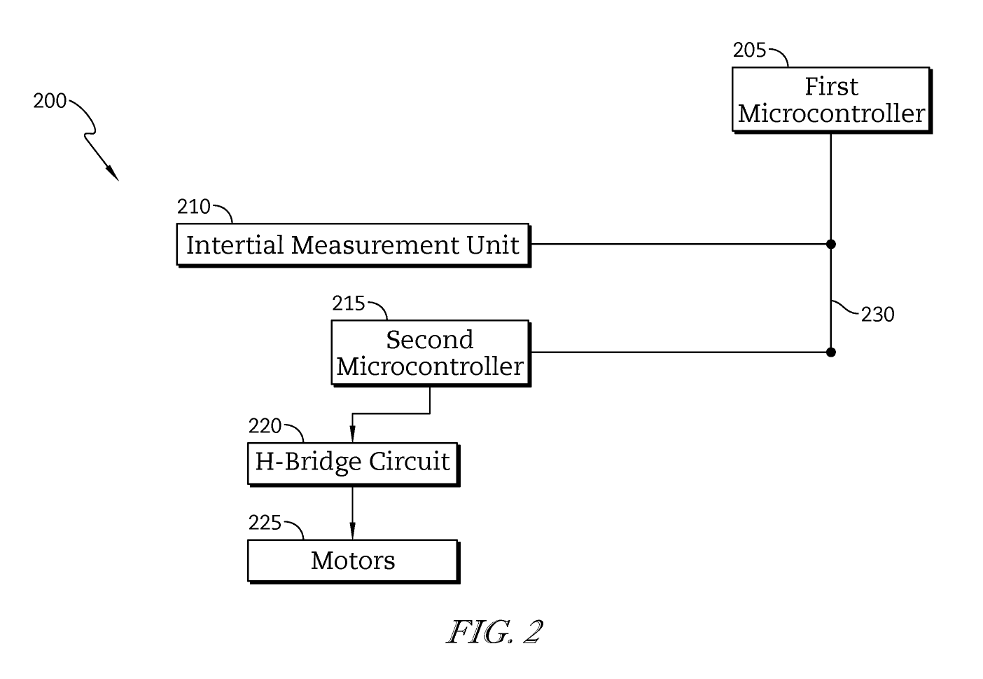

FIG. 2 shows a block diagram depicting system hardware components for a system 200 in accordance with an illustrative embodiment of the present disclosure. The system 200 is an exemplary implementation for what was previously described in connection with FIG. 1. The system 200 includes a first microcontroller 205, an Intertial Measurement Unit (“IMU”) 210, a second microcontroller 215, an H-Bridge circuit 220, and motors 225. The arrangement shown in FIG. 2, including the division of computational workload to be described below, allows for mounting of actuators in a way that maximizes force and minimizes complexity and power consumption. By splitting computation between first and second microcontroller units 205 and 215, the system 200 can control and suppress involuntary movements in real time and with minimum delay.

The components depicted in FIG. 2 are configured in a master/slave architecture, with the first microcontroller 205 operating as a master and the IMU 210 and second microcontroller 215 operating as slaves. In certain embodiments, the master/slave architecture is implemented using an I2C line 230, with the first microcontroller 205 on an I2C line 230 to which both the IMU 210 and second microcontroller 215 are connected.

The IMU 210 includes sensors, such as one or more gyroscopes and one or more accelerometers. In certain embodiments, the sensors are all provided on the same circuit board. The first microcontroller 205 continuously requests data from the IMU 210 and performs the necessary calculations to determine what response the system 200 should provide to counteract involuntary movements. According to one embodiment, the first microcontroller 205 checks every 30 milliseconds to see if motor motion is required.

If motor motion is required, the first microcontroller 205 sends a data packet to the second microcontroller 215 specifying the direction and velocity that are required from the motors 225. The second microcontroller 215 then sends a series of pulses to an H-Bridge circuit 220 that corresponds to the necessary motion. The H-Bridge circuit 220 is a current source for the motors 225, and may also provide electrical isolation between the EMF-sensitive second microcontroller 215 and the motors 225. In certain embodiments, a separate H-Bridge circuit 220 may be provided for each respective motor among the motors 225.

According to certain embodiments, the functionality of the first and second microcontrollers 205 and 215 is provided in a programming language that is suitable for compilation to and execution on microcontrollers, such as the C programming language or assembly programming languages. By allowing signal processing and computations to be performed in on-board microcontrollers, the system 200 can be implemented as an embedded system. Embedded, microcontroller-based systems are useful for providing computational power within a portable device without the need for the device to communicate with external computers. Embedded, microcontroller-based systems are also well suited for systems that require computations to be performed in real time and with minimal delay, as is the case for the system 200.

Exemplary C programming language code that can be used to control the motors (e.g., code that, after compilation, could be executed on the second microcontroller 215) is attached hereto as Appendix A. Exemplary C programming language code that can be used to communicate with a motor controller and with sensors (e.g., code that, after compilation, could be executed on the first microcontroller 205) is attached hereto as Appendix B. The code attached hereto as Appendix B can also be used to communicate with a diagnostics workstation, to be discussed below.

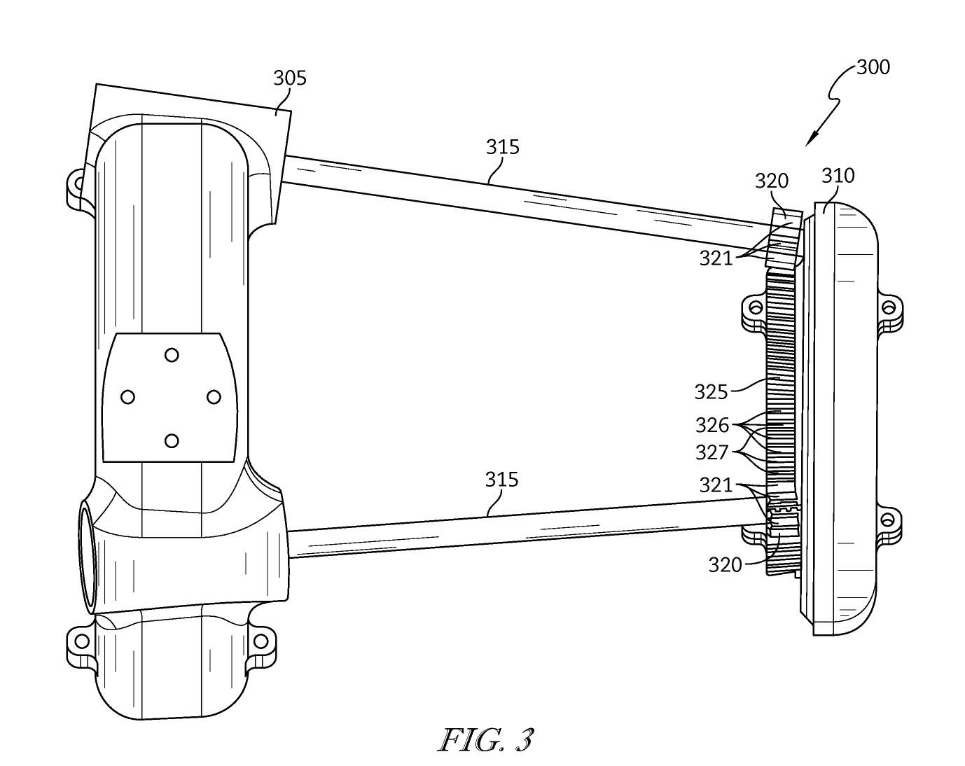

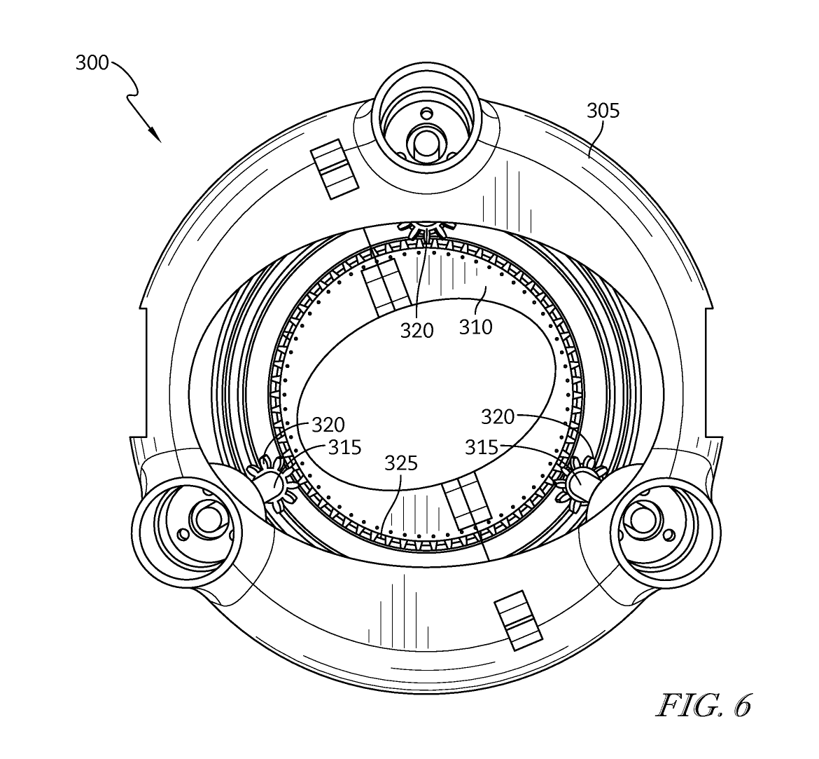

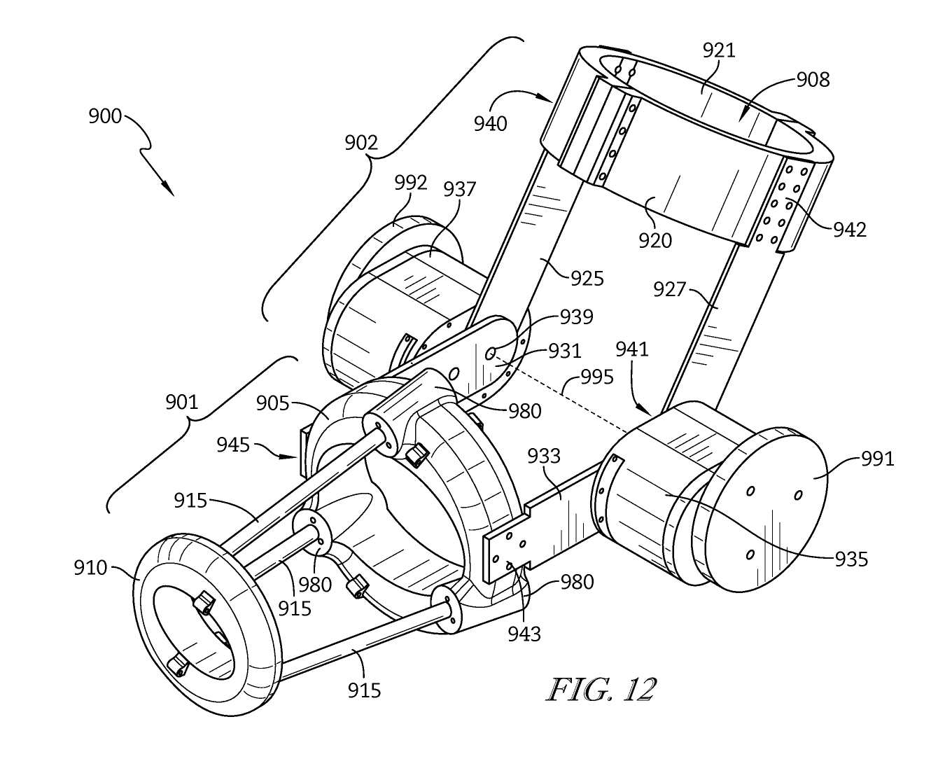

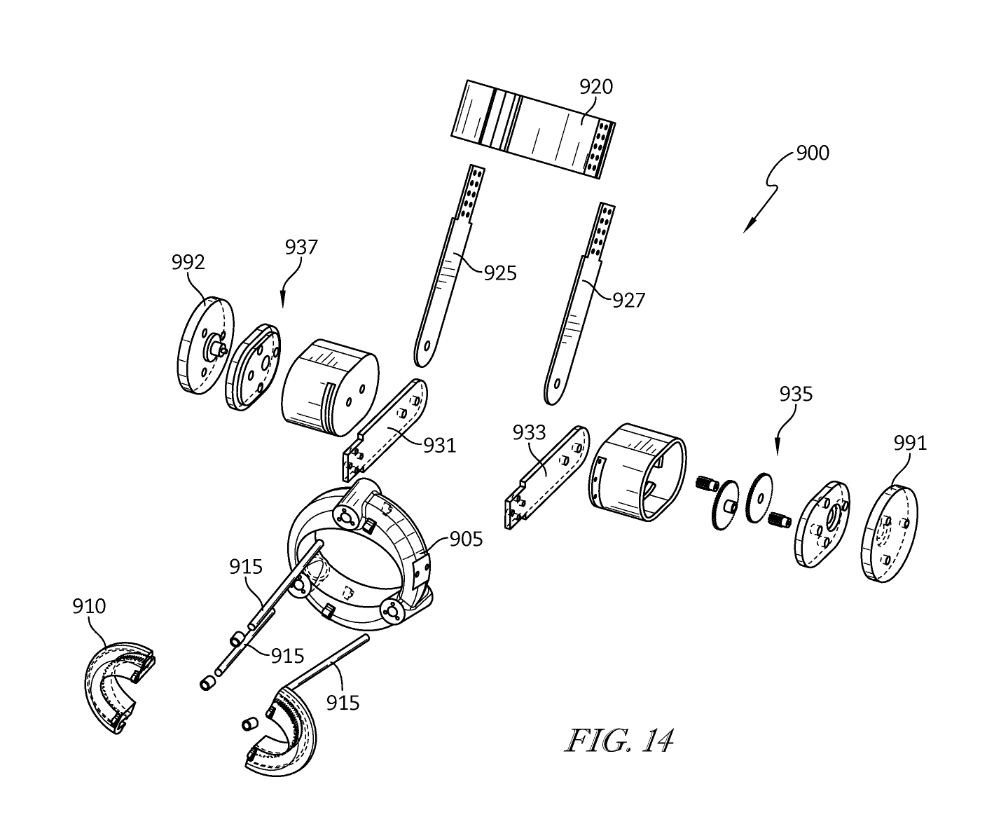

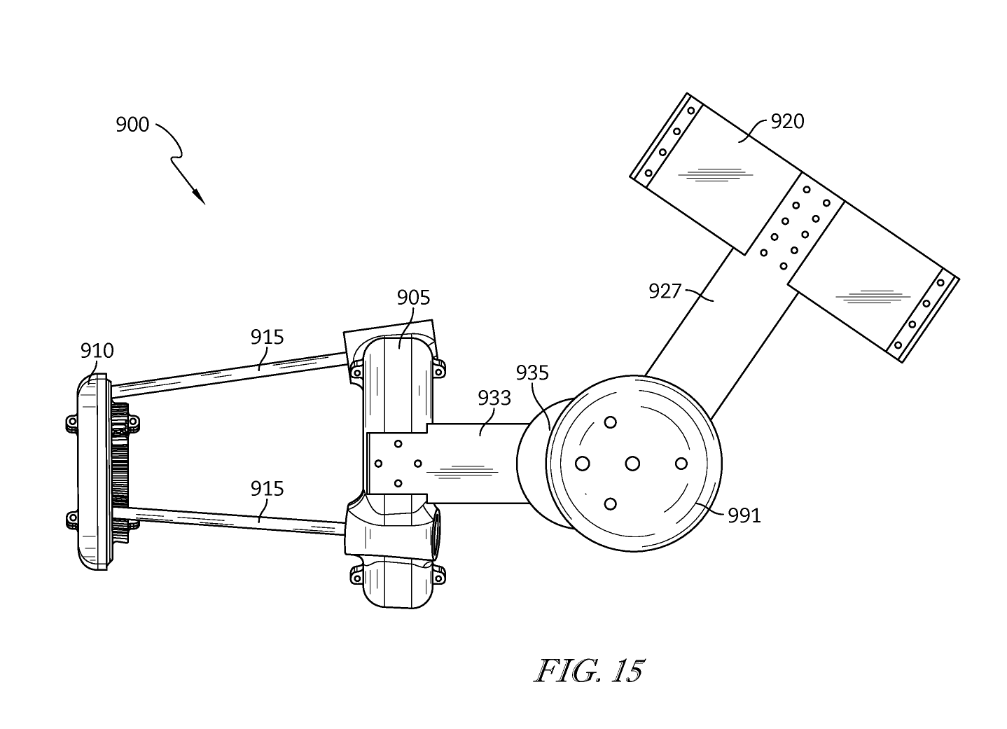

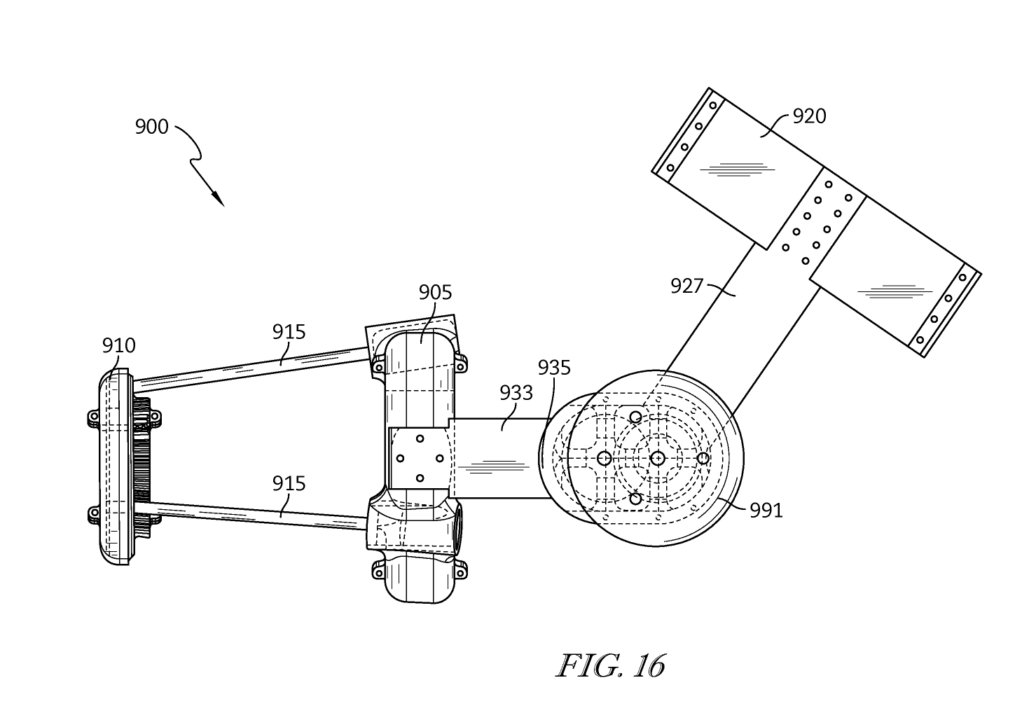

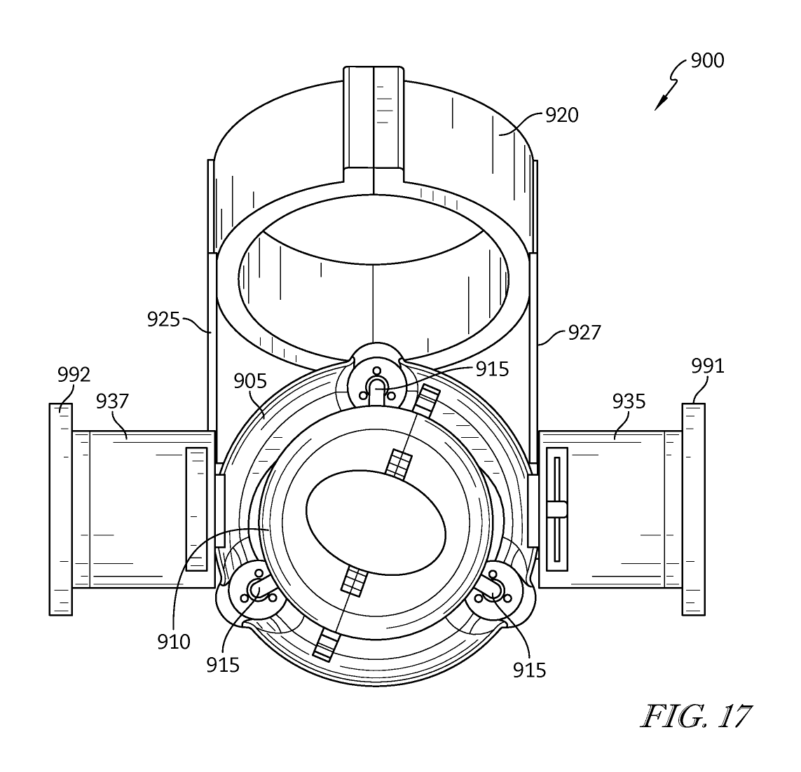

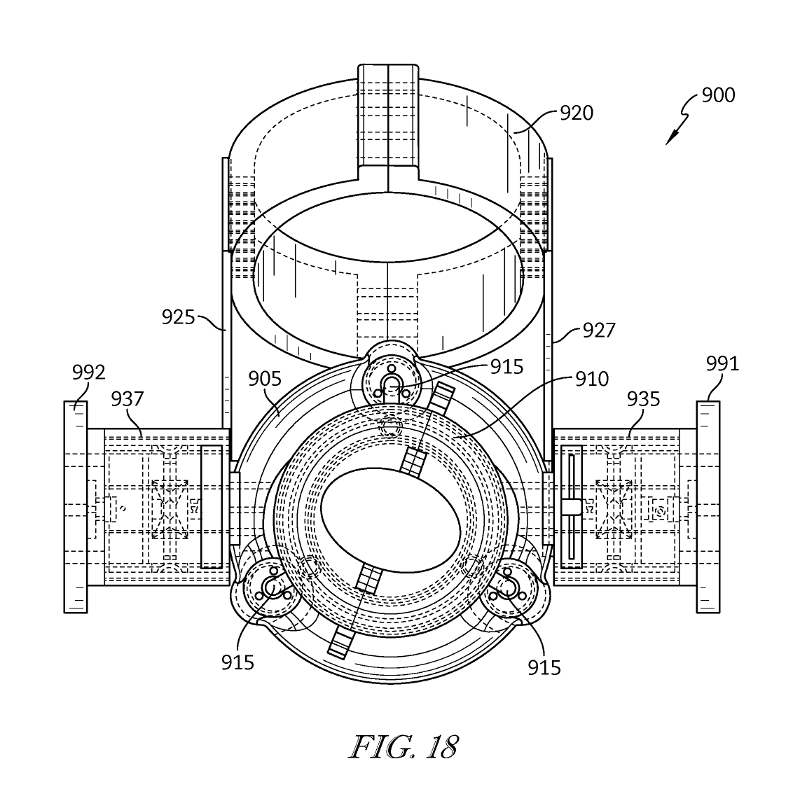

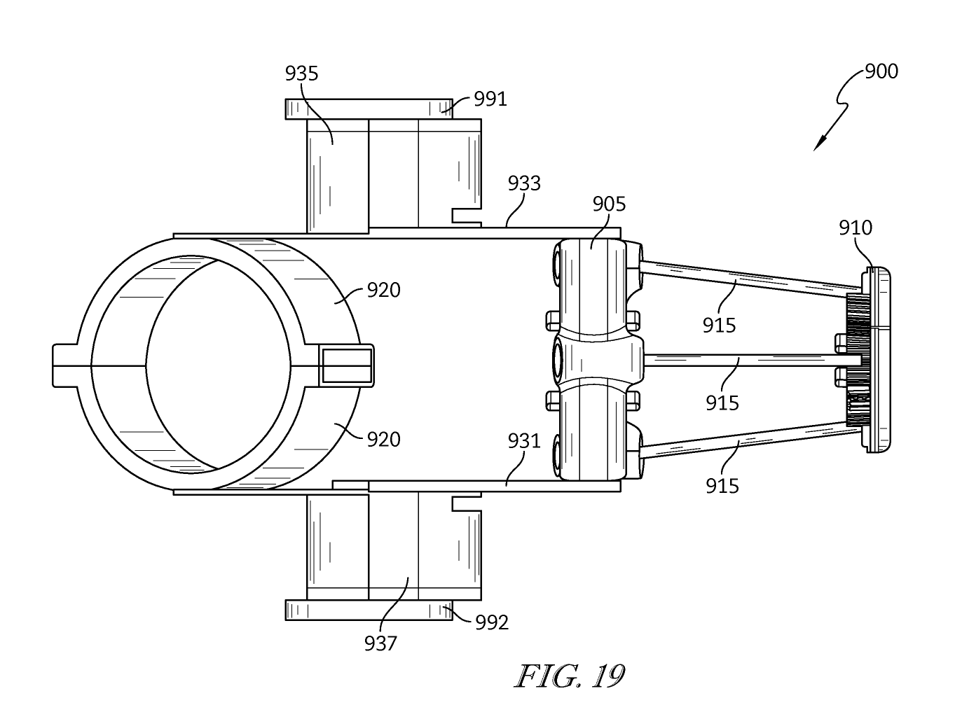

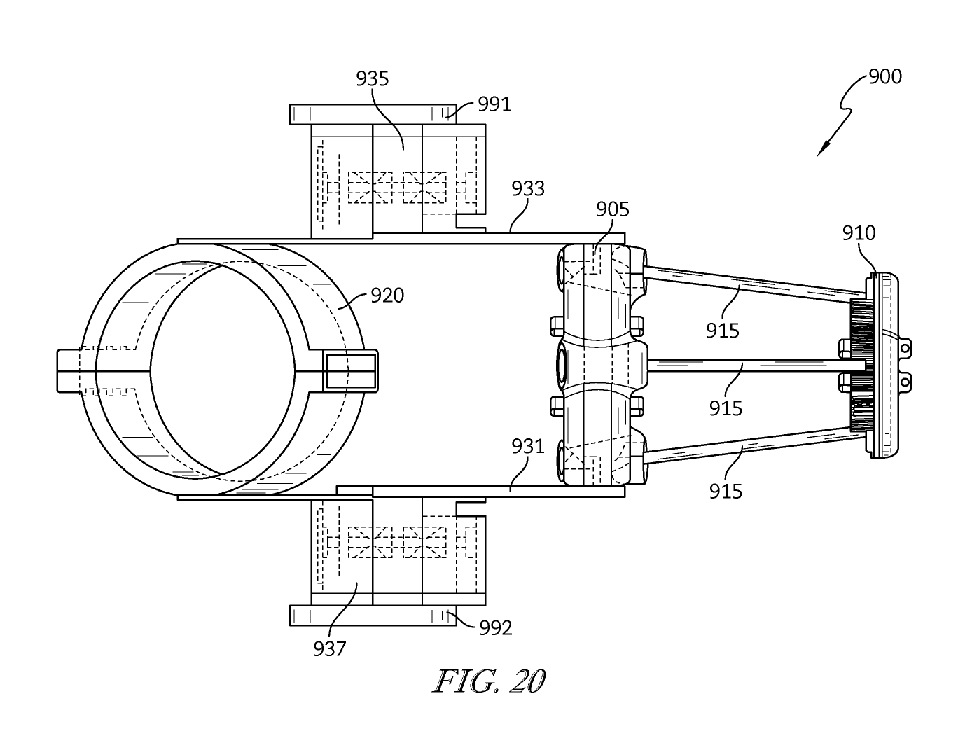

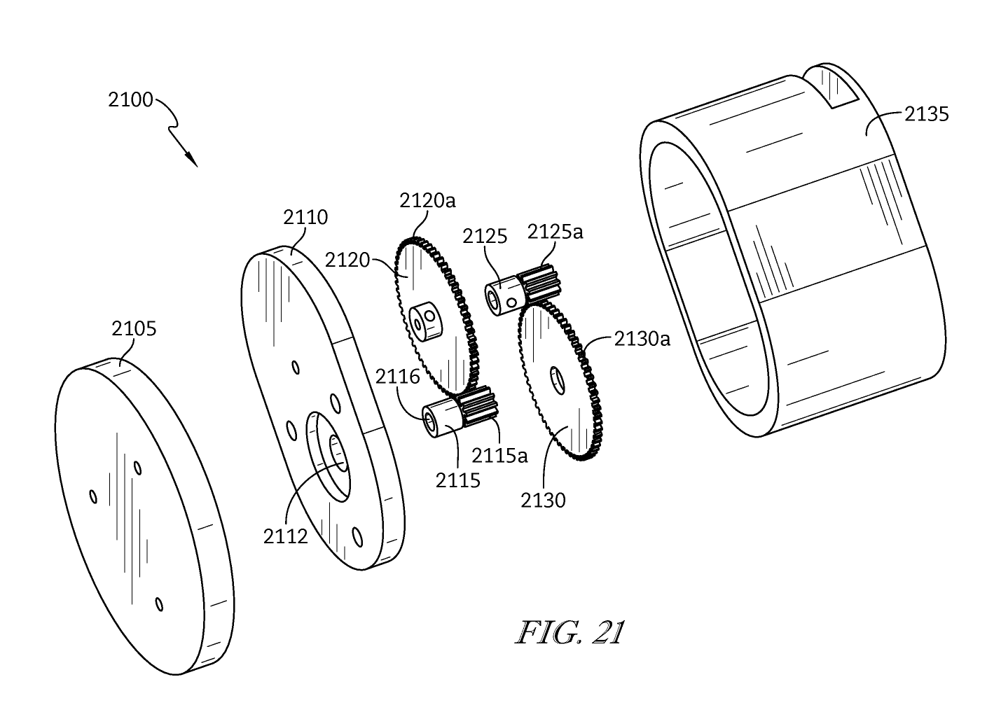

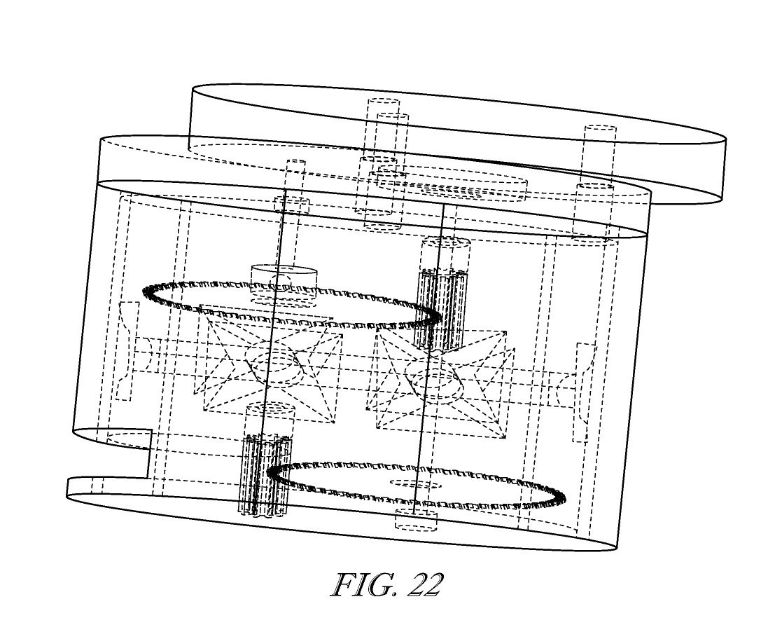

Structural features of an exoskeleton in accordance with the present disclosure will now be discussed in connection with FIGS. 3-22. By way of overview, FIGS. 3-6 and 8-11 show a partial exoskeleton 300 having just a forearm portion, FIGS. 12-20 show structural features of an exoskeleton 900 having forearm and bicep portions, FIG. 7 shows a connection between components of the exoskeleton with a workstation used for diagnostic analysis, and FIGS. 21-22 show a gearbox. An exoskeleton in accordance with the present disclosure can include just a forearm portion as depicted in connection with partial exoskeleton 300, or a forearm and bicep portion as depicted in connection with exoskeleton 900. Thus, all descriptions offered below in connection with partial exoskeleton 300 are applicable to a forearm portion of the exoskeleton 900 as well.

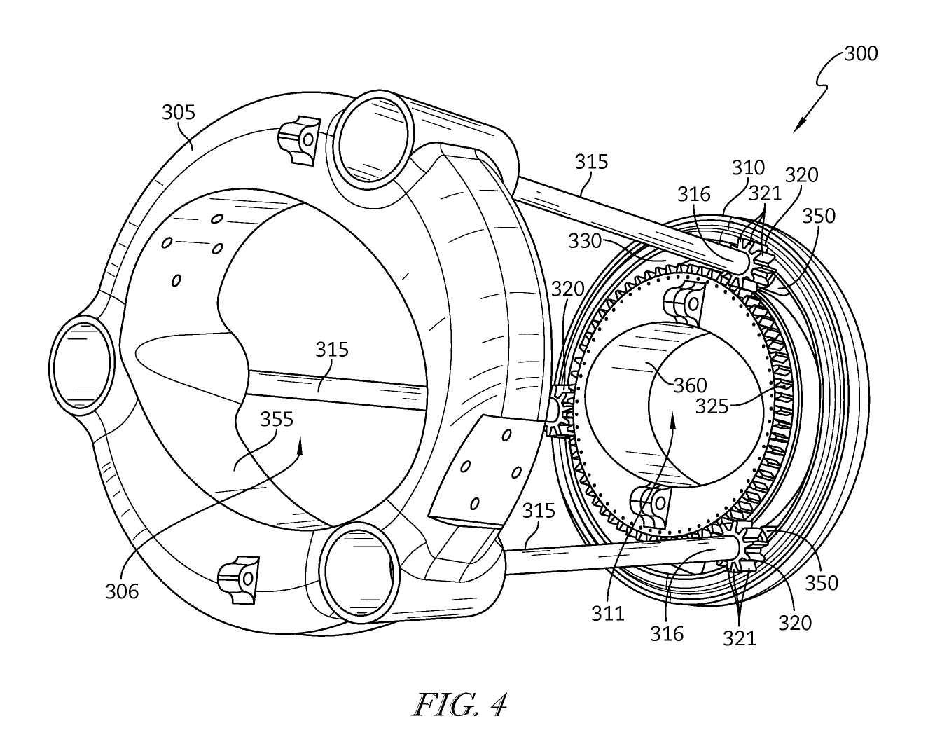

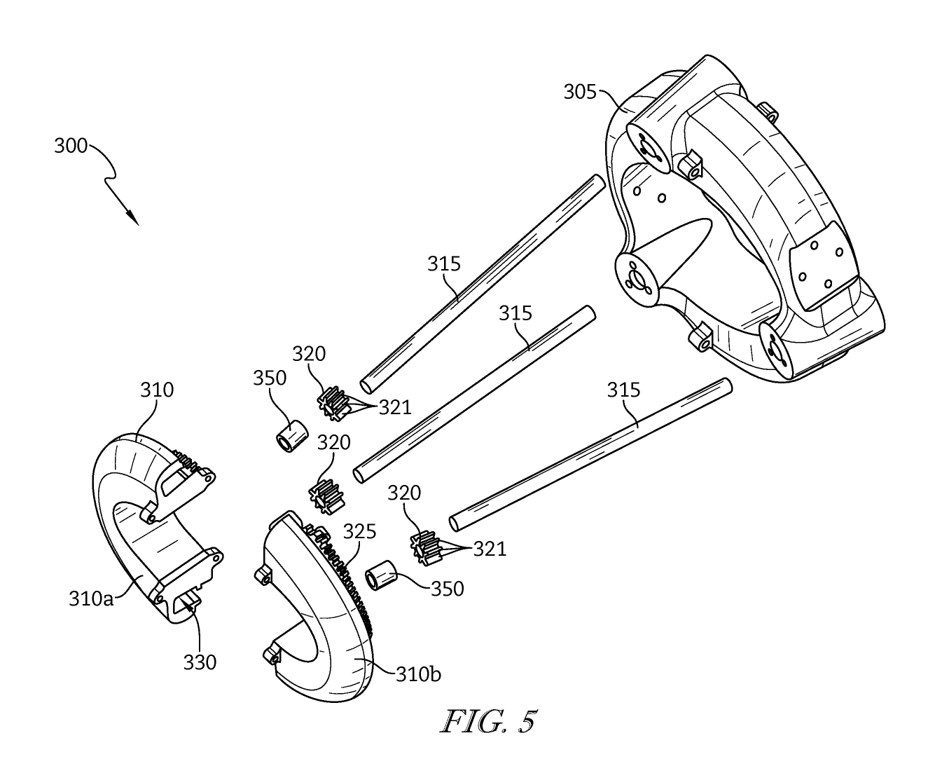

FIG. 3 shows a side perspective view of the structural features of a partial exoskeleton 300 in accordance with an illustrative embodiment of the present disclosure. The partial exoskeleton 300 comprises a first cuff 305, a second cuff 310 spaced apart from the first cuff 305, and one or more rotatable shafts 315 extending between the first cuff 305 and the second cuff 310. In illustrative embodiments, the first cuff 305 and the second cuff 310 are circular in nature. The first cuff 305 is configured to include a first aperture 306 (shown in FIG. 4) and the second cuff 310 is configured to include a second aperture 311 (shown in FIG. 4). The first and second apertures 306 and 311 are configured to permit a portion of a patient's body to extend through the first and second cuffs 305 and 310, respectively, and to permit the first and second cuffs 305 and 310 to securely fit around a relevant portion of the patient's body. In illustrative embodiments, the first cuff 305 is configured to be secured around a patient's upper arm and the second cuff 310 is configured to be secured around a patient's forearm. As shown in FIG. 5, the second cuff 310 can be provided as two semi-circular structures that are joined to result in an annular structure.

In illustrative embodiments, the partial exoskeleton 300 can include cushions to improve the fit of the partial exoskeleton 300 to a patient's arm. Specifically, a first annular-shaped cushion (not shown) may be adjoined to an interior surface 355 (shown in FIG. 4) of the first cuff 305. The first annular-shaped cushion may be shaped and sized as to leave unobstructed a sufficient portion of the first aperture 306 to allow a patient's forearm to fit therethrough, while also maintaining a snug fit with the patient's forearm. The first annular-shaped cushion may be made of a soft material or be filled with a padding as to improve patient comfort. Similarly, a second annular-shaped cushion (not shown) may be adjoined to an interior surface 360 (shown in FIG. 4) of the second cuff 310. The second annular-shaped cushion may be shaped and sized as to leave unobstructed a sufficient portion of the second aperture 311 to allow a patient's upper arm to fit therethrough, while also maintaining a snug fit within the patient's upper arm. The second annular-shaped cushion may be made of a soft material or be filled with a padding as to improve patient comfort.

As illustrated in FIG. 3, the first and second cuffs 305 and 310 are connected with rotatable shafts 315 that are configured to extend substantially parallel to a patient's arm. Specifically, the rotatable shafts 315 are coupled to the first and/or second cuffs 305 and 310 via one or more pinions 320. In illustrative embodiments, the rotatable shafts 315 are fixedly connected to the pinions 320. The pinions 320 include one or more pinion teeth 321 that extend circumferentially around the pinion 320.

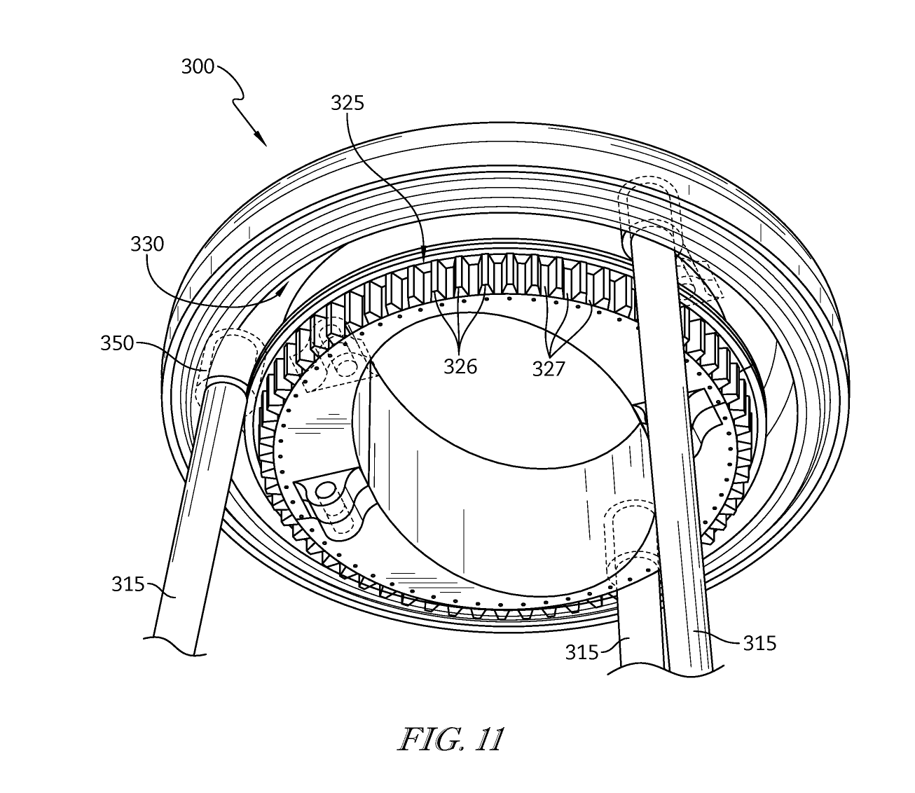

As illustrated in in FIG. 4, the second cuff 310 includes an annular track 325 that is circumferentially outside of the second aperture 311. The annular track 325 is fixedly connected to the second cuff 310. The annular track 325 includes track teeth 326 spaced apart from each other and formed to include teeth grooves 327 therebetween, shown also in FIG. 11. Upon rotation of the rotatable shafts 315, the pinions 320 rotate. Upon rotation of the pinions 320, the pinion teeth 321 are configured to engage with the teeth grooves 327 of the annular track 325. Thus, rotation of the pinions 320 drives rotation of the track 325, resulting in rotation of the second cuff 310. In this manner, the system 300 allows for rotatable movement of the second cuff 310 when a patient voluntarily pronates or supinates his or her forearm while wearing the partial exoskeleton 300.

In illustrative embodiments, one or more motors (not shown) may be coupled to and are capable of driving rotation of the rotatable shafts 315. Specifically, the one or more motors can operate to allow or prevent rotation of the rotatable shafts 315. In doing so, the motors allow or prevent rotation of the patient's arm. In this manner, the motors can control and moderate involuntary supination or pronation movements.

A gearbox (to be discussed in more detail in connection with FIGS. 21-23) may be included to improve the torque characteristics of the motors by increasing a maximum torque that can be delivered to the patient's arm. In illustrative embodiments, thin, curved plates (not shown) extending between the rotatable shafts 315 may be provided with the partial exoskeleton 300 to hold each of the rotatable shafts 315 in consistent placement with respect to one another. Such curved plates would be configured to provide structural integrity to the partial exoskeleton 300 and maintain that structural integrity notwithstanding patient movements.

FIGS. 4-6 illustrate various views of structural features of a partial exoskeleton 300 in accordance with the present disclosure. The first and second cuffs 305 and 310, the rotatable shafts 315, the pinions 320, and the track 325 are shown. First ends 316 (shown in FIG. 4) of the rotatable shafts 315 abut the second cuff 310 and may include hooking members 350 (shown in FIG. 4) hooked within a channel 330 disposed within the cuff 310. The hooking members 350 maintain the rotatable shaft 315 in engagement with the second cuff 310, while also permitting the second cuff 310 to rotate as to allow the patient to voluntarily pronate and supinate. In order to permit the second cuff 310 to rotate, the hooking members 350 may be made of a low friction material that can slide substantially freely within the channel 330. In illustrative embodiments, the hooking members 350 may be Howlite low-friction beads, which fit within the channel 330 disposed within the cuff 310.

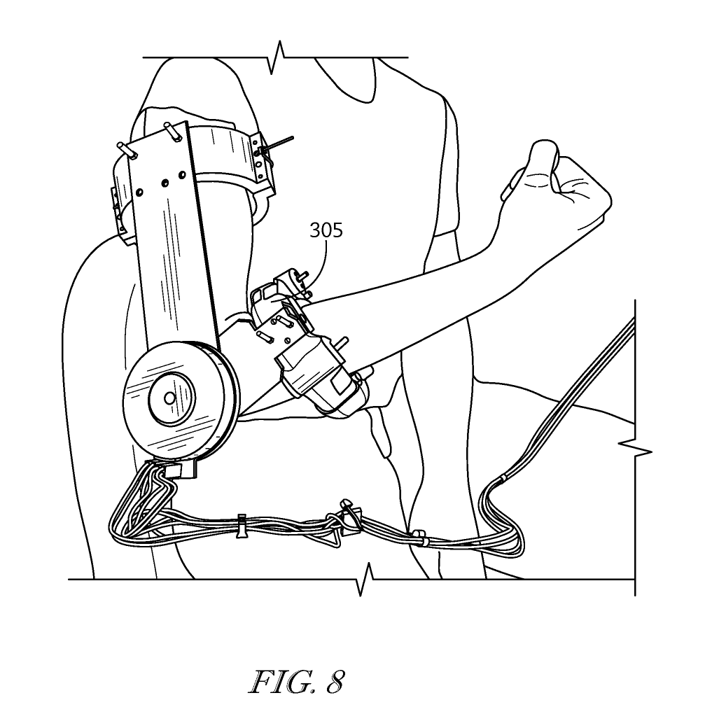

FIG. 7 shows a connection between components of the partial exoskeleton 300 with a workstation 700 used for diagnostic analysis. The connection between the partial exoskeleton 300 can be through a wired connection (as depicted in FIG. 8) (e.g., a USB connection) or the exoskeleton may be equipped with wireless functionality, allowing for remote communications between the partial exoskeleton 300 and the workstation 700. The connection between the partial exoskeleton 300 and the workstation 700 allows data to be transmitted in both directions between microcontrollers and IMU's on the exoskeleton on the one hand and the workstation on the other hand. The workstation 700 includes software that can be coded in any language suitable for use in desktop applications, including C, C++, or Java.

The workstation 700 can be used for a number of purposes. As explained above, parameters used in the transfer functions for filtering elements in the filter subsystem 110 and parameters used in the control subsystem 115 can be specifically customized for a particular patient. To achieve this, the patient can wear the prosthetic 300 for a period of time, during which information about the patient's voluntary and involuntary movements are transmitted to the workstation 700. The workstation can analyze the data received in order to determine filter and control system characteristics that are optimally suited for that particular patient. The software can convert the signals it receives into the frequency domain using a Fast Fourier Transform and then perform analysis to identify filter and control system characteristics specific to a patient.

According to another use, the workstation 700 can receive data from the partial exoskeleton 300 for debugging and testing purposes.

According to yet another use, the workstation 700 can generate reports which assess the effectiveness of a given control strategy, save data regarding tremorous activity for subsequent observation, and load saved data regarding tremors for analysis and comparison.

Exemplary code that could be used to run a desktop application in accordance with the present disclosure is appended hereto as Appendix C.

FIG. 8 shows a photograph of a portion of a partial exoskeleton 300 in accordance with the present disclosures. FIG. 8 does not depict certain forearm portions of the partial exoskeleton 300.

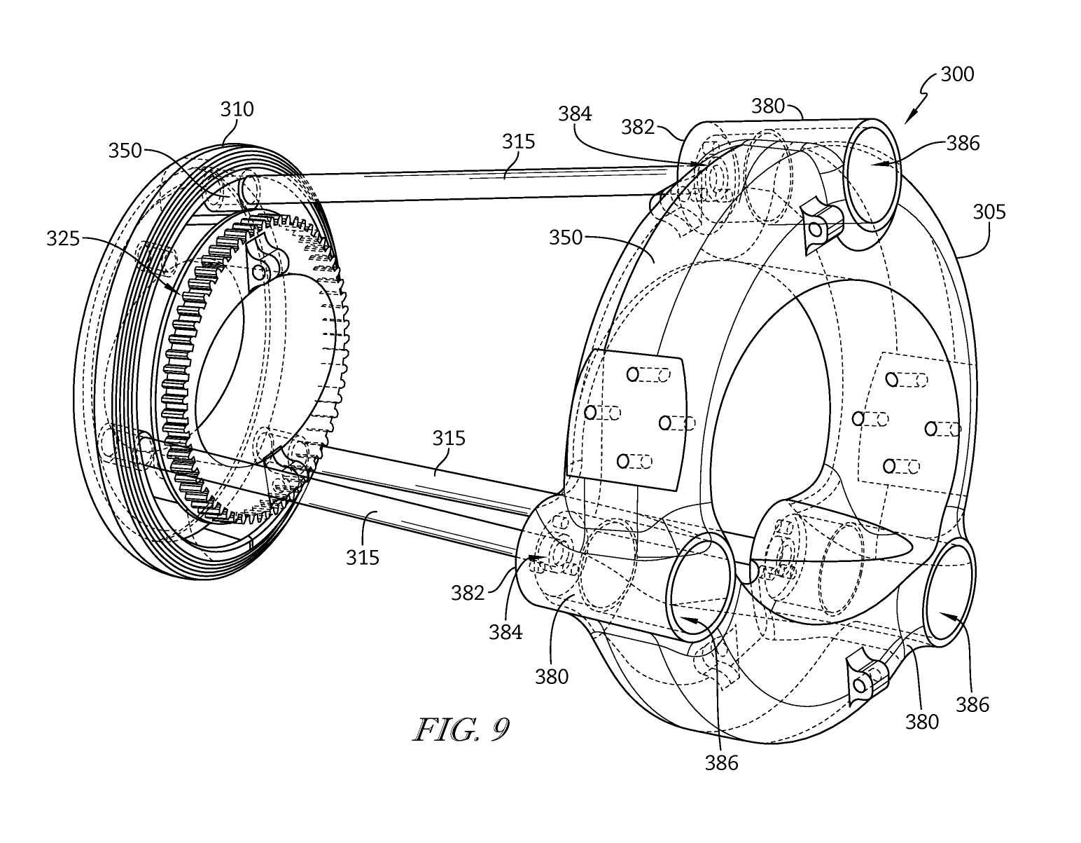

FIG. 9 shows a side angled perspective view of structural features of a partial exoskeleton 300 in accordance with the present disclosure. FIG. 9 shows three encasements 380. Each of the three encasements 380 are substantially identical. The encasements 380 are generally cylindrical in shape. The encasements 380 include respective top ends 382, in which a circular opening 384 is disposed. The circular opening 384 is shaped and sized to fit a rotatable shaft 315 therethrough. The encasements 380 include hollow interior portions 386. In certain embodiments, the hollow interior portions 386 can house motors (not shown), with one motor disposed in each of the three hollow interior portions 386. The motors can couple to the rotatable shafts 315 within the encasements 380 in order to drive the pinions 320 as described above.

The fabrication materials and methodologies for partial exoskeleton 300 may be configured for a multi-user fit, may be inexpensive and easy to manufacture, may be durable and water-resistant, and may offer enhanced patient comfort. In certain embodiments, the partial exoskeleton 300 may be fabricated using aluminum. In other embodiments, the partial exoskeleton 300 can be manufactured from leather. In still other embodiments, the partial exoskeleton 300 can be manufactured from carbon-fiber/Plexiglas composites. Other fabrication materials are also envisioned and encompassed in the present invention.

In still other embodiments, the partial exoskeleton 300 can be manufactured using 3-D printing techniques that use lightweight, composite polymers. The use of 3-D printing offers the benefit that the partial exoskeleton 300 can be custom-fitted and custom-designed for a particular patient. The use of lightweight materials is advantageous at least because it allows the patient more easily to engage in voluntary movements and does not require substantial patient strength to wear the partial exoskeleton 300. A further benefit of 3-D printing is that features such as gearing can be disposed directly within the structural components of the partial exoskeleton 300 in certain embodiments.

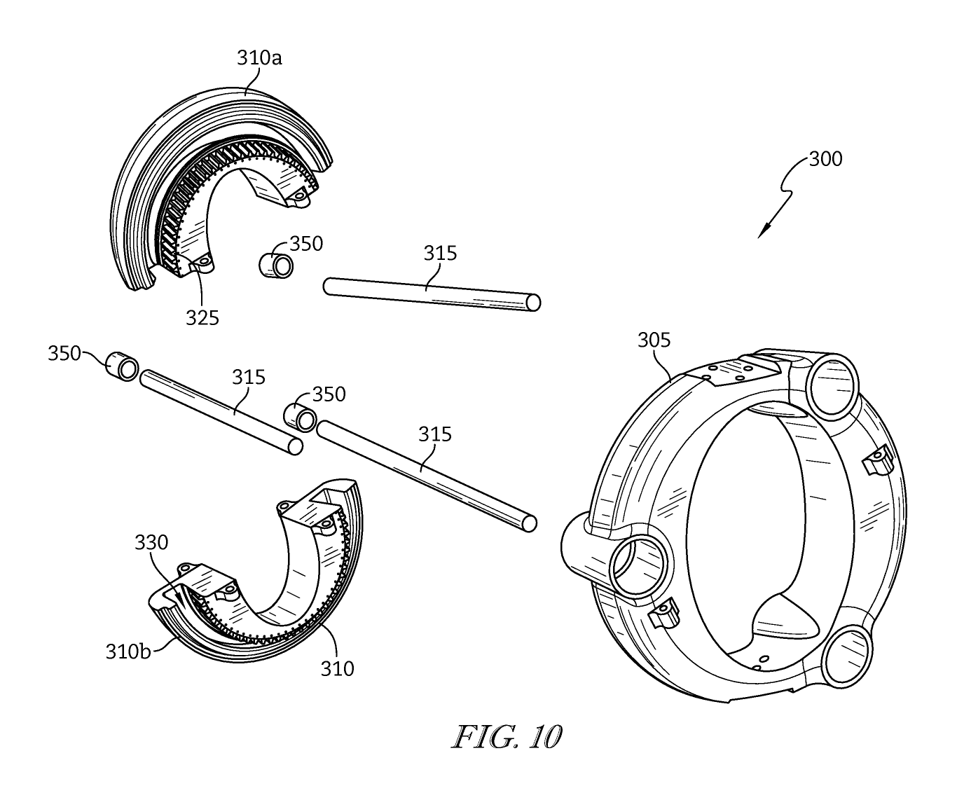

FIGS. 10-11 illustrate still other views of structural features of a partial exoskeleton 300, with the pinions 320 removed.

FIG. 12 illustrates an exoskeleton 900 that has a forearm portion generally indicated at 901 and a bicep portion generally indicated at 902. In illustrative embodiments, the forearm portion 901 is substantially identical to the partial exoskeleton 300 depicted in the figures described above, and it should be understood that the descriptions offered in connection with partial exoskeleton 300 apply to the forearm portion 901 of the exoskeleton 900. In certain embodiments, the partial exoskeleton 300 can be provided for a patient that requires only forearm support on a stand-alone basis, and in other embodiments, the patient is provided with an exoskeleton that includes both a forearm portion 901 and a bicep portion 902 as shown in connection with exoskeleton 900.

Thus, the forearm portion 901 includes a first cuff 905, a second cuff 910, and rotatable shafts 915, the components being substantially similar to the first cuff 305, second cuff 310, and rotatable shafts 315 described above. The exoskeleton 900 also includes a third cuff 920 spaced apart from the first cuff 905. The third cuff 920 is configured to include an aperture 908. The aperture 908 is configured to permit a portion of a patient's body to extend therethrough and to permit the third cuff 920 to securely fit around a relevant portion of the patient's body. In illustrative embodiments, the third cuff 920 is configured to be secured around the portion of a patient's arm proximate to the patient's bicep and tricep.

An annular-shaped cushion (not shown) may be adjoined to an interior surface 921 of the third cuff 920 to improve the fit of the exoskeleton 900 to a patient's arm. The annular-shaped cushion may be shaped and sized as to leave unobstructed a sufficient portion of the first aperture 908 to allow the portion of the patient's arm proximate to the patient's bicep and tricep to fit therethrough, while also maintaining a snug fit with that portion of the patient's forearm. The annular-shaped cushion may be made of a soft material or be filled with a padding as to improve patient comfort.

The exoskeleton 900 includes first and second hinged extensions 925 and 927 that attach to the third cuff 920 at locations 940 and 942, respectively. The first and second hinged extensions 925 and 927 extend in substantially parallel fashion with respect to one another, and extend in a direction that is substantially parallel to an axis defined by the portion of the patient's arm above the patient's elbow.

The first and second hinged extensions 925 and 927 are configured to be coupled to third and fourth hinged extensions 931 and 933, respectively. Specifically, the first hinged extension 925 couples to the third hinged extension 391 at hinge 939, and the second hinged extension 927 couples to the fourth hinged extension 933 at hinge 941. The hinges 939 and 941 may make use of hinge mechanisms that are known in the art, such that first hinged extension 925 can rotate with respect to third hinged extension 931 about an axis 995 defined by the hinge 939. Similarly, the second hinged extension 927 can rotate with respect to the fourth hinged extension 933 about an axis defined by the hinge 941 (obstructed from view).

The third hinged extension 931 attaches to the first cuff 905 at a location 945, and the fourth hinged extension 933 attaches to the first cuff 905 at a location 943. In this manner, the first, second, third, and fourth hinged extensions 925, 927, 931, and 933 collectively operate to attach the third cuff 940 to the forearm portion 901, and to allow the third cuff 940 to rotate relative to the forearm portion 901 about the axis defined by hinges 939 and 941. This rotation permits a patient wearing the exoskeleton 900 to freely engage in extension and flexion about the patient's elbow.

FIG. 12 also shows first and second gearbox assemblies 935 and 937, a bottom portion of a first motor assembly 991, and a bottom portion of a second motor assembly 992. The first motor assembly 991 is associated with the first gearbox assembly 935 and the second motor assembly 992 is associated with the second gearbox assembly 937. The first motor assembly 991 may drive gears (to be described in connection with FIG. 21) disposed within the first gearbox assembly 935 as to apply torque to a patient's arm in order to prevent involuntary flexion and/or extension about the elbow. The second motor assembly 992 may drive gears (to be described in connection with FIG. 21) disposed within the second gearbox assembly 937 as to apply torque to a patient's arm in order to prevent involuntary flexion and/or extension about the elbow.

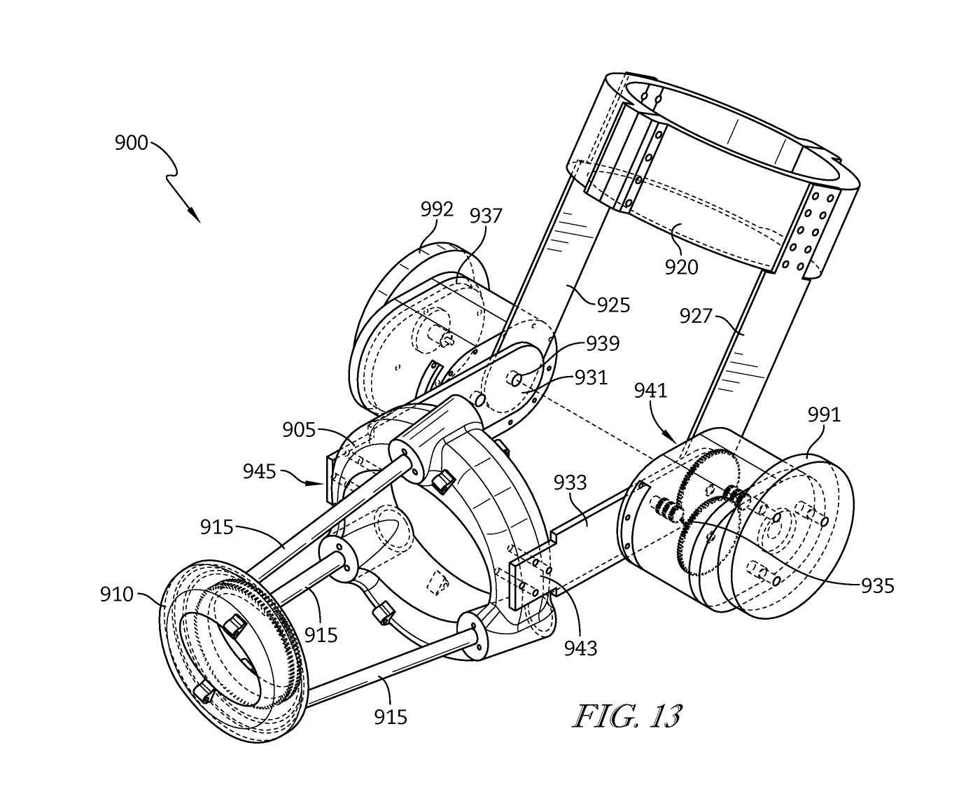

FIGS. 13-20 illustrate various views of structural features of an exoskeleton 900 in accordance with the present disclosure, and depict the structural elements discussed above in connection with FIG. 12.

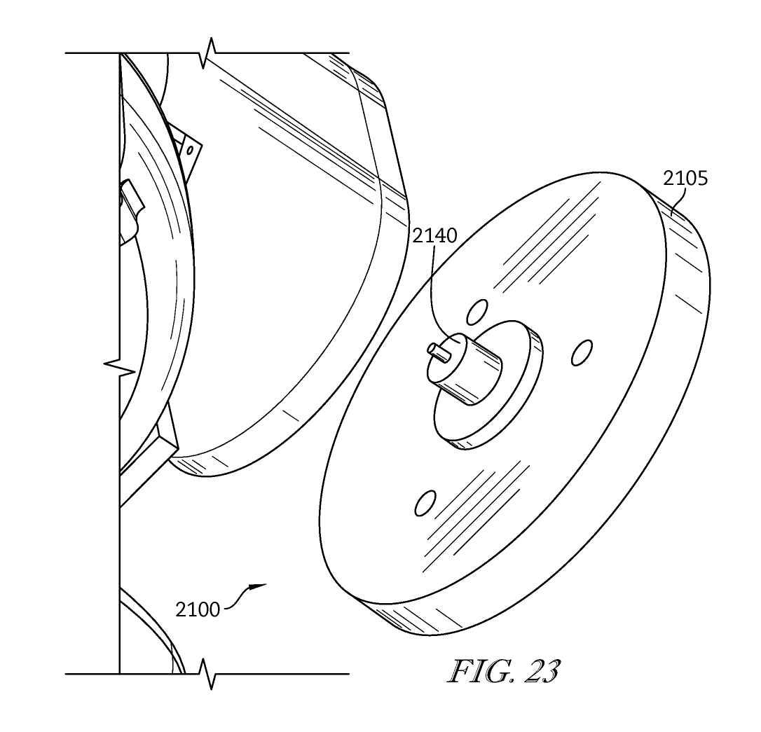

FIGS. 21-23 illustrate the components of a gearbox assembly 2100 in accordance with the present disclosure, such as gearbox assemblies 935 and 937. The gearbox assembly 2100 includes a cover plate 2110, a first gearing mechanism 2115, a second gearing mechanism 2120, a third gearing mechanism 2125, and a fourth gearing mechanism 2130. Also shown is a bottom portion of a motor assembly 2105, which is similar to the bottom portion of the first motor assembly 991 and the bottom portion of the second motor assembly 992 shown in connection with FIG. 12. The motor assembly 2105 includes an axle 2140 (shown in FIG. 23). Upon actuation of the motor assembly 2105, the axle 2140 rotates.

The cover plate 2110 includes an aperture 2112 through which the first gearing mechanism 2115 and the axle 2140 can interconnect. Specifically, the axle 2140 fits within an aperture 2116 of the first gearing mechanism 2115 in order to rotatably couple the axle 2140 and the first gearing mechanism 2115. The first gearing mechanism 2115 has surface features 2115a that intermesh with gear teeth 2120a disposed on a circumference of the second gearing mechanism 2120. The second gearing mechanism 2120 and the third gearing mechanism 2125 are operably connected as to rotate in concert. The third gearing mechanism 2125 has surface features 2125a that intermesh with gear teeth 2130a disposed on a circumference of the fourth gearing mechanism 2130.

In operation, the axle 2140 of the motor assembly 2105 (for which, as mentioned, only a bottom portion is shown) drives the rotation of the first gearing mechanism 2115. The rotation of the first gearing mechanism 2115 drives the rotation of the second gearing mechanism 2120. The rotation of the second gearing mechanism 2120 drives the rotation of the third gearing mechanism 2125. The rotation of the third gearing mechanism 2125 drives the rotation of the fourth gearing mechanism 2130. The rotation of the fourth gearing mechanism 2130 applies torque to the patient's arm. Due to the gear ratios present among the gearing mechanisms 2115, 2120, 2125, and 2130, the speed of rotation of the fourth gearing mechanism 2130 will be slower than that of the first gearing mechanism 2115, yielding a higher output torque for the fourth gearing mechanism 2130. This higher torque provides more effective control for countering involuntary arm movements on the part of the patient.

It should be understood that the materials with which the exoskeleton 900 is manufactured and the method of manufacturing exoskeleton 900 may be the same as those described above in connection with partial exoskeleton 300. Thus, the fabrication materials and methodologies for exoskeleton 900 may be configured for a multi-user fit, may be inexpensive and easy to manufacture, may be durable and water-resistant, and may offer enhanced patient comfort. In certain embodiments, the exoskeleton 900 may be fabricated using aluminum. In other embodiments, the exoskeleton 900 can be manufactured from leather. In still other embodiments, the exoskeleton 900 can be manufactured from carbon-fiber/Plexiglas composites. Other fabrication materials are also envisioned and encompassed in the present invention.

As with the partial exoskeleton 300, the exoskeleton 900 can be manufactured using 3-D printing techniques that use lightweight, composite polymers. The use of 3-D printing offers the benefit that the partial exoskeleton 300 can be custom-fitted and custom-designed for a particular patient. The use of lightweight materials is advantageous at least because it allows the patient more easily to engage in voluntary movements and does not require substantial patient strength to wear the exoskeleton 900. A further benefit of 3-D printing is that features such as gearing can be disposed directly within the structural components of the exoskeleton 900 in certain embodiments.

It should further be understood that the system 100 (described above in connection with FIG. 1) and the system 200 (described above in connection with FIG. 2) may apply to either or both of partial exoskeleton 300 and/or exoskeleton 900. Thus, in certain embodiments involving partial exoskeleton 300, the motor subsystem 120 shown in FIG. 1 and the motors 225 shown in FIG. 2 include three motors (not shown), with each motor disposed in respective encasements 380. In certain embodiments involving exoskeleton 900, the motor subsystem 120 shown in FIG. 1 and the motors 225 shown in FIG. 2 include five motors: three motors (not shown) disposed in respective encasements 980 (shown in FIG. 12), one motor associated with gearbox 937, and one motor associated with gearbox 935.

It should likewise be understood that the workstation 700, described above in connection with FIG. 7, may be connected to exoskeleton 900 in the same fashion and for the same purposes as partial exoskeleton 300.

The microcontrollers disclosed herein may include computer-readable media/memory for carrying or having computer-executable instructions or data structures stored thereon, a processor, and input and output mechanisms. The memory can be in the form of RAM or ROM, including SRAM or EEPROM. Existing commercially available microcontrollers are known to those of ordinary skill and could be suitable for use with the systems disclosed herein, including microcontrollers from Texas Instruments, Analog Devices, Intel, and the like.

The workstations disclosed herein can include a processor, computer-readable media/memory, and input/output mechanisms, such as a monitor, keyboard, mouse, and the like. The memory can include any available media that can be accessed by a general purpose or special purpose computer. By way of example, and not limitation, such computer-readable media can comprise physical storage and/or memory media such as RAM, ROM, EEPROM, and the like, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions. Commercially available workstations are known and suitable for use with the systems disclosed herein.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure.

### PUBLICATIONS

These publications are incorporated by reference to the extent they relate materials and methods disclosed herein.

As'arry, A., Zain, M. Z., Mailah, M., Hussein, M., and Yusop, Z. M., Active Tremor Control in 4-DOFs Biodynamic Hand Model, International Journal of Mathematical Models and Methods in applied Sciences, Issue 6, Volume 5, 1068-1076, 2011.

Case D., Taheri, B., and Richer, E., A lumped Parameter model for Dynamic MR Damper control, Proceedings of the ASME 2013 Dynamic Systems and Control Conference, DSCC2013, Palo alto, Calif., Oct. 21-23, 2013.

Case, D., Taheri, B., Richer, E., Dynamic Magnetorheological Damper for Orthotic Tremor Suppression, Issue 99, pp: 1-8, August 2011.

Chowdary, S. and Gupta, A., “Active Vibration Control of Essential Tremor”, 14th National Conference on Machines and Mechanisms, NIT Durgapur, India, Dec 2009, Paper #BSMC-3.

Ganti, S., Suppression of Essential Tremor, MS thesis, Department of Mechanical Engineering, Northern Illinois University, Dec 2013.

Grimaldi, G. Lammertse, P. Van Den Braber, N. Meuleman, J., and Manto, M., Evaluating manual control devices for those with tremor disability, IEEE Transactions on Biomedical Circuits and Systems, Volume 2 Issue: 4, pp: 269-279, Dec. 2008.

Hall, G. E, “Active Tremor Control of Human Motion Disorder”, Masters of Science thesis, Massachusetts Institute of Technology, 2001.

Kotovsky, J. and Rosen, M. J., A wearable tremor-suppression Orthosis, Journal of Rehabilitation Research and Development Vol. 35 No. 4, Pages 373-387, October 1998.

Manto, M., Topping, M., Soede, M., Sanchez-Lacuesta J., Harwin, W., Pons, J., Williams, J.,

Skaarup, S., and Normie, L., Dynamically Responsive Intervention for Tremor Suppression, De Montfort University, UK, Volume 22 Issue:3, pp: 120-132, May-June. 2003.

Rocon, E., Belda-Lois, J. M., Sanchez-Lacuesta J., and Pons, J., Pathological tremor management: Modelling compensatory technology and evaluation, Technology and Disability, volume 16, pp 3-18, 2004.

Winters, J., Barish, P., Agarwal, N., Jackson, J., Sherman, E., and Barish, T. T., Wearable Essential Tremor Solution, University of Florida, Biomedical Engineering.

1. A device for moderating involuntary movement of a patient, comprising:
an exoskeleton fitted to the patient, the exoskeleton including at least a first cuff;
a motor configured to drive the first cuff to apply torque to an arm of the patient;
a sensor configured to generate a signal indicative of the movement;
a filter for distinguishing a portion of the signal reflecting voluntary movement from a portion of the signal reflecting involuntary movement; and
a control system configured to operate the motor such that the torque applied to the arm of the patient counters the involuntary movement; wherein
at least one of the filter and the control system is provided on a microcontroller having a processor, a non-transitory data storage component, and computer readable code that, when executed, processes the signal using parameters selected based on analysis of prior movements of the patient.

2. The device of claim 1, wherein the filter is programmed to filter signals in accordance with a transfer function; and the transfer function is iteratively customized for the patient based on previously measured characteristics of voluntary movements and involuntary movements among the prior movements of the patient.

3. The device of claim 1, wherein the control system is a proportional integral derivative controller; and the proportional integral derivative controller is programmed with coefficients customized for the patient based on characteristics of voluntary movements and involuntary movements among the prior movements of the patient.

4. The device of claim 1, comprising a first microcontroller that is embedded within the device and a second microcontroller distinct from the first microcontroller that is embedded within the device, wherein:
the first microcontroller contains computer code which, when executed by the first microcontroller, causes the first microcontroller to:
request data from the sensor;
compute a motor direction and a motor velocity suitable for countering the involuntary movement; and
transmit a first signal indicative of the computed motor direction and the computed motor velocity to the second microcontroller; and
the second microcontroller contains computer code which, when executed by the second microcontroller, causes the second microcontroller to transmit a second signal indicative of the computed motor direction and the computed motor velocity to a current source for the motor.

5. The device of claim 1, further comprising a gearbox having a plurality of intermeshing gearing mechanisms that increase the torque applied to the arm of the patient.

6. The device of claim 5, further comprising:
a gearbox having a first gearing mechanism rotatably drivable by the motor;
at least one intermediate gearing mechanism intermeshed with the first gearing mechanism; and
an output gearing mechanism that applies torque to the arm of the patient.

7. The device of claim 1, wherein the exoskeleton further includes a second cuff, the first cuff and the second cuff configured to surround a portion of the arm of the patient and connected together by at least one rotatable shaft.

8. The device of claim 7, wherein the second cuff includes an annular track capable of receiving one or more pinions connected to the rotatable shaft such that rotation of the rotatable shaft causes the one or more pinions to travel along the annular track.

9. The device of claim 7, wherein the first cuff includes at least one encasement that receives the at least one rotatable shaft, the encasement permitting the motor to be connected to the rotatable shaft to rotate the rotatable shaft within the encasement.

10. The device of claim 7, wherein the exoskeleton includes three rotatable shafts extending between the first cuff and the second cuff.

11. A system for moderating involuntary movement of a patient, comprising:
an exoskeleton configured to apply torque to an arm of the patient upon actuation of motors coupled to the exoskeleton; and
a microcontroller embedded within the exoskeleton; wherein
the embedded microcontroller includes a processor, a non-transitory data storage component, and computer readable code that, when executed, generates a signal output that actuates the motors and causes the exoskeleton to apply a torque that counters the involuntary movement.

12. The device of claim 11, wherein the embedded microcontroller includes a digital filter programmed with computer code which, when executed by the microcontroller, causes the filter to filter signals in accordance with a transfer function; and
the transfer function is iteratively customized for the patient based on measured characteristics of previous voluntary movements and involuntary movements of the patient.

13. The device of claim 11, wherein the embedded microcontroller includes a digital proportional integral derivative controller programmed with computer code which, when executed by the microcontroller, causes the digital proportional integral derivative controller to apply control coefficients customized for the patient.

14. The device of claim 11, wherein the embedded microcontroller contains computer code which, when executed by the embedded microcontroller, causes the embedded microcontroller to:
request data from the sensor;
compute motor directions and motor velocities suitable for countering the involuntary movement; and
transmit signals indicative of the computed motor directions and the computed motor velocities to a second microcontroller;
and wherein the exoskeleton includes a second embedded microcontroller that includes a processor, a non-transitory data storage component, and computer readable code which, when executed by the second embedded microcontroller, causes the second embedded microcontroller to transmit signals indicative of the computed motor directions and the computed motor velocities to one or more current sources for the motors.

15. The device of claim 11, further comprising a gearbox having a plurality of intermeshing gearing mechanisms that increase the torque applied to the arm of the patient.

16. The device of claim 11, further comprising:
a gearbox having a first gearing mechanism rotatably drivable by the motor;
at least one intermediate gearing mechanism intermeshed with the first gearing mechanism; and
an output gearing mechanism that applies torque to the arm of the patient.

17. The device of claim 11, wherein the exoskeleton includes a first cuff configured to surround a portion of the patient's arm, a second cuff configured to surround a portion of the patient's arm, and at least one rotatable shaft extending therebetween that permits rotation of the second cuff relative to the first cuff.

18. The device of claim 17, wherein the exoskeleton further includes at least one gearbox assembly coupled to the first cuff.

19. The device of claim 17, wherein the exoskeleton further includes a third cuff spaced apart from the first cuff, the third cuff configured to surround a portion of the patient's arm.

20. The device of claim 11, wherein the exoskeleton comprises lightweight, composite polymers.
